(19) United States
(12) Patent Application Publication
(10) Pub. No.: US 2006/0245390 A1
(43) Pub. Date: Nov. 2, 2006

(54) Base station and mobile station constituting mobile communication system

(76) Inventors: Yukihiro Omoto, Osaka (JP); Hideki Nakahara, Hyogo (JP); Tomohiro Kimura, Osaka (JP); Kenichi Mori, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/411,836

(22) Filed: Apr. 27, 2006

(30) Foreign Application Priority Data
Apr. 28, 2005 (JP) 2005-131958

(51) Int. Cl. H04Q 7/00

(52) U.S. Cl. 370/328

(57) ABSTRACT

In a mobile communication system in which the same frequency channel f1 is used to perform communication of the same data between a moving mobile station 2 and a plurality of base stations 1a to 1d while sequentially establishing synchronization therebetween, subcarriers assigned to the base stations 1a to 1d are set so as to satisfy the following conditions. 1. The same frequency channel f1 is used for all the base stations. 2. Subcarriers do not overlap between adjacent base stations. 3. Adjacent subcarriers are not used in each subcarrier set. 4. All subcarriers within the frequency channel f1 (subcarriers having closest intervals which can hold an orthogonal relationship) are used.

### BACKGROUND OF THE INVENTION

1. Field of the Invention

The present invention relates to a base station and a mobile station constituting a mobile communication system. More particularly, the present invention relates to an intercarrier interference suppressing process and a handover process in a mobile communication system which employs a multicarrier modulating technique.

2. Description of the Background Art

In recent years, as the variety of use's needs for multimedia and the like is increased in the information and communication field, the amount of data to be handled tends to increase. Therefore, also in the mobile communication field, a communication technique for high-capacity transmission is essentially required. Particularly, there is a possibility that a communication technique capable of achieving high-capacity transmission during high-speed movement will cause mobile information terminal apparatuses and the like to become more widespread.

As means for achieving high-capacity transmission, a multicarrier modulating technique is known. For example, IEEE standard 802.11a for wireless LAN employs a multicarrier modulating technique which uses Orthogonal Frequency Division Multiplexing (OFDM) to achieve a transmission capacity which has a maximum wireless transmission rate of 54 Mbps. In the multicarrier modulating technique, a frequency band is divided into a plurality of subcarriers, and a high-rate serial data stream is converted into low-rate parallel data streams, which are in turn modulated. Since a large number of narrow-band subcarriers are used to transmit a signal, the signal is less affected by channel frequency characteristics, so that high-rate transmission can be easily achieved (Non-patent Document 1: Richard van Nee and Ramjee Prasad, “OFDM for Wireless Multimedia Communications”, Artech House, 2000).

However, in the multicarrier modulating technique, the subcarriers are arranged, overlapping each other, and therefore, are easily affected by channel frequency variation due to multipath fading. This is because the instantaneous carrier wave frequency of each subcarrier varies randomly, so that an orthogonal relationship between each subcarrier is destroyed, and one subcarrier leaks into and mutually interferes with another subcarrier. This interference is generally called intercarrier interference (ICI). When a Doppler shift is large due to high-speed movement, an influence of ICI leads to a deterioration in transmission rate. Therefore, when the multicarrier modulating technique is applied to a mobile communication system with high-speed movement, the influence of ICI needs to be reduced.

Also in the mobile communication system, a plurality of base stations form respective communication areas. When a mobile station performs communication while passing through the communication areas, the mobile station successively changes base stations with which the mobile station communicates (i.e., a so-called handover process). When transmission signals transmitted from the base stations have different center frequencies, the mobile station needs to change frequency channels for receiving a signal in the handover process, and therefore, a complicated process, such as clock resynchronization, frequency resynchronization, or the like, is required. Therefore, a high-speed pull-in oscillator, a plurality of oscillators, or the like need to be provided, so that cost reduction is hindered (see Patent Document 3: Japanese Patent No. 3045167). Since communication is interrupted during the time when a synchronization process is performed, as communication areas are changed in shorter time intervals (i.e., more frequently), the proportion of the synchronization process time with respect to a transmission permitted time increases when high-speed movement is performed, so that the transmission permitted time within a communication area becomes insufficient (see Patent Document 2: Japanese Patent Laid-Open Publication No. 2000-134667). Thus, when the multicarrier modulating technique is applied to a mobile communication system, the handover process needs to be further simplified.

As a conventional technique for reducing the influence of the above-described ICI, there is a known technique for suppressing the occurrence of ICI in a road-to-vehicle communication system which employs an OFDM modulation method (see Patent Document 1: Japanese Patent No. 3127918). FIG. 15 is a schematic diagram illustrating a conventional mobile communication system which employs the OFDM modulation method of Patent Document 1. FIG. 16 is a diagram for explaining a method of arranging subcarriers used in the conventional mobile communication system of FIG. 15. The conventional mobile communication system is configured to use the same frequency channel f1 (bandwidth W1) to perform communication of the same data between a plurality of base stations 1a to 1d and a mobile station 2 while sequentially establishing synchronization therebetween.

In the conventional mobile communication system, the speed of the mobile station 2 moving in a communication area is detected, and based on the result of the detection, a subcarrier set (a carrier group including a plurality of subcarriers) which is used in the base stations 1a to 1d is simultaneously changed. Referring to FIG. 16, when the moving speed of the mobile station 2 is low, a low-speed subcarrier set including all subcarriers for the frequency channel f1 is used; when the moving speed of the mobile station 2 is intermediate, an intermediate-speed subcarrier set including a less reduced number of subcarriers is used; and when the moving speed of the mobile station 2 is high, a high-speed subcarrier set including a more reduced number of subcarriers is used. Note that these sets are dynamically changed. Thus, by increasing the frequency interval between subcarriers which are used for communication, depending on the speed of the mobile station 2, the occurrence of mutual interference between each subcarrier due to the Doppler shift is inhibited, thereby suppressing the influence of the ICI during high-speed movement.

As a conventional technique for simplifying the handover process, there is a known technique of changing channels while holding synchronization without performing a resynchronization process during handover in a mobile communication system which employs a multicarrier modulating technique (see Patent Document 2). FIG. 17 is a schematic diagram illustrating a conventional mobile communication system employing an OFDM modulation method which is described in Patent Document 2. FIG. 18 is a diagram for explaining a method of arranging subcarriers used in the conventional mobile communication system of FIG. 17. This conventional mobile communication system is also configured to use the same frequency channel f1 (bandwidth W1) to perform communication of the same data between a plurality of base stations 1a to 1d and a mobile station 2 while sequentially establishing synchronization therebetween.

In this conventional mobile communication system, the frequency channel f1 is divided into two channels (i.e., a lower frequency channel and a higher frequency channel), and a set of subcarriers on the lower frequency channel and a set of subcarriers on the higher frequency channel are alternately provided for the base stations 1a to 1d as illustrated in FIG. 17. Thus, since carrier frequencies used in adjacent communication areas are different from each other, all the subcarriers of the frequency channel f1 are received in an area where communication areas overlap (hereinafter referred to as an overlapping communication area). Therefore, by subjecting a signal received in an overlapping communication area, as one channel, to a demodulation process, a handover process is achieved while holding clock synchronization.

In the technique of Patent Document 1, although ICI can be suppressed, a multipath phenomenon occurs in an overlapping communication area. This is because adjacent base stations forming an overlapping communication area perform communication using the same frequency channel. In this case, there is a possibility that, when signals from adjacent base stations having an equal power and reverse phases are added together, the received signals are completely canceled.

In the technique of Patent Document 2, although the process amount of handover can be reduced, the frequency interval between subcarriers is equal to that of a normal case where the number of subcarriers is not reduced, so that the occurrence of ICI due to a Doppler shift during high-speed movement cannot be avoided.

Note that a combination technique of Patent Document 1 and Patent Document 2 is considered, however, as illustrated in FIG. 19, the number of subcarriers used in a frequency band for performing a demodulation process is reduced by a factor of ½ as compared to Patent Document 1 and Patent Document 2. Therefore, the transmission of the same amount of data as that of Patent Document 1 or Patent Document 2 requires a double frequency band, resulting in half the frequency efficiency.

### SUMMARY OF THE INVENTION

Therefore, an object of the present invention is to provide a base station and a mobile station which constitute a mobile communication system which employs a multicarrier modulating technique and are capable of suppressing ICI and simplifying a handover process.

The present invention is directed to a base station and a mobile station constituting a mobile communication system in which station-to-station communication is performed using a multicarrier modulating technique, and a method performed in the stations. To achieve the object of the present invention, the base station of the present invention comprises a subcarrier set storing section operable to store information about a subcarrier set designating a plurality of subcarriers used in communication, a subcarrier arranging section operable to generate modulation data obtained by providing transmission data only to the plurality of subcarriers designated by the subcarrier set, and a modulation section operable to modulate the modulation data generated by the subcarrier arranging section into a base-band transmission signal based on the multicarrier modulating technique. The mobile station of the present invention comprises a demodulation section operable to demodulate a base-band received signal into demodulated data based on the multicarrier modulating technique, and a demodulated data selection combining section operable to determine which of a plurality of predetermined subcarrier sets was used to transmit data, based on the demodulated data, and generate received data obtained by selecting a plurality of subcarriers designated by the determined subcarrier set, from the demodulated data.

The subcarriers designated by the subcarrier set used in the base station and the mobile station are included in the same frequency channel as that of at least another adjacent base station, and are different from subcarriers of the adjacent base station, and adjacent subcarriers are not used in each subcarrier set. Note that, in the frequency channel, a plurality of subcarriers are arranged in closest intervals which can hold an orthogonal relationship between each subcarrier.

Typically, the base station further comprises an S/P conversion section operable to convert serial-format transmission data into parallel-format transmission data and output the parallel-format transmission data to the subcarrier arranging section, a P/S conversion section operable to convert the base-band transmission signal modulated by the modulation section into a serial format, and an RF transmission section operable to convert the serial-format base-band transmission signal into an analog signal and up-convert the analog signal into a predetermined frequency band, and thereafter, output the resultant analog signal through an antenna. Also, the base station may further comprises an encoding section operable to subject the serial-format transmission data to an error correction encoding process to output an encoded transmission signal, and an interleaving section operable to rearrange a temporal sequence of the encoded transmission signal and output the resultant encoded transmission signal to the S/P conversion section.

The subcarriers designated by the subcarrier set may be subdivided into a plurality of subcarrier sets, and broadcast communication can be performed with respect to a plurality of mobile stations within a communication area using the plurality of subcarrier sets. In this case, preferably, a control signal for informing of a subcarrier set used for communication is transmitted to the plurality of mobile stations within a communication area using a carrier of a predetermined control channel, or using a specific subcarrier of the plurality of subcarriers.

According to the present invention, a frequency interval between each subcarrier is broadened, thereby making it possible to suppress occurrence of ICI due to a Doppler shift during high-speed movement. A mobile station does not need to change frequency channels for a received signal during handover, so that a handover process can be easily performed only by changing subcarrier sets used. Since all subcarriers included in a frequency channel are used, there is not a reduction in the frequency efficiency. Since subcarriers do not overlap between adjacent base stations, received signals are not canceled in an overlapping communication area. In addition, even when an error exceeding the error correction capability occurs in an overlapping communication area, the error can be suppressed into an error correction capability range, whereby all data can be decoded.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram illustrating a mobile communication system according to a first embodiment of the present invention;

FIG. 2 is a diagram for explaining arrangement of subcarriers used in the mobile communication system of the first embodiment;

FIG. 3 is a block diagram illustrating an exemplary configuration of base stations 1a to 1d of the first embodiment;

FIG. 4 is a block diagram illustrating an exemplary configuration of a mobile station 2 of the first embodiment;

FIG. 5 is a schematic diagram illustrating another mobile communication system according to the first embodiment of the present invention;

FIG. 6 is a diagram for explaining arrangement of subcarriers used in the mobile communication system of FIG. 5;

FIG. 7 is a schematic diagram illustrating a mobile communication system according to a second embodiment of the present invention;

FIG. 8 is a diagram for explaining arrangement of subcarriers used in the mobile communication system of the second embodiment;

FIG. 9 is a block diagram illustrating an exemplary configuration of base stations 1a to 1d of the second embodiment;

FIG. 10 is a block diagram illustrating an exemplary configuration of mobile stations 2a to 2c of the second embodiment;

FIG. 11 is a diagram for explaining another method of arranging subcarriers used in the mobile communication system of the second embodiment;

FIG. 12 is a block diagram illustrating an exemplary configuration of base stations 1a to 1d of the third embodiment;

FIG. 13 is a block diagram illustrating an exemplary configuration of a mobile station 2 of the third embodiment;

FIGS. 14A to 14C are conceptual diagrams illustrating a relationship between a passage time when a mobile station pass through an overlapping communication area and a bit error rate;

FIG. 15 is a schematic diagram illustrating a conventional mobile communication system;

FIG. 16 is a diagram for explaining arrangement of subcarriers used in the mobile communication system of FIG. 15;

FIG. 17 is a schematic diagram illustrating another conventional mobile communication system;

FIG. 18 is a diagram for explaining arrangement of subcarriers used in the mobile communication system of FIG. 17; and

FIG. 19 is a diagram for explaining an exemplary subcarrier arrangement which can be considered from conventional techniques.

### DESCRIPTION OF THE PREFERRED EMBODIMENTS

### First Embodiment

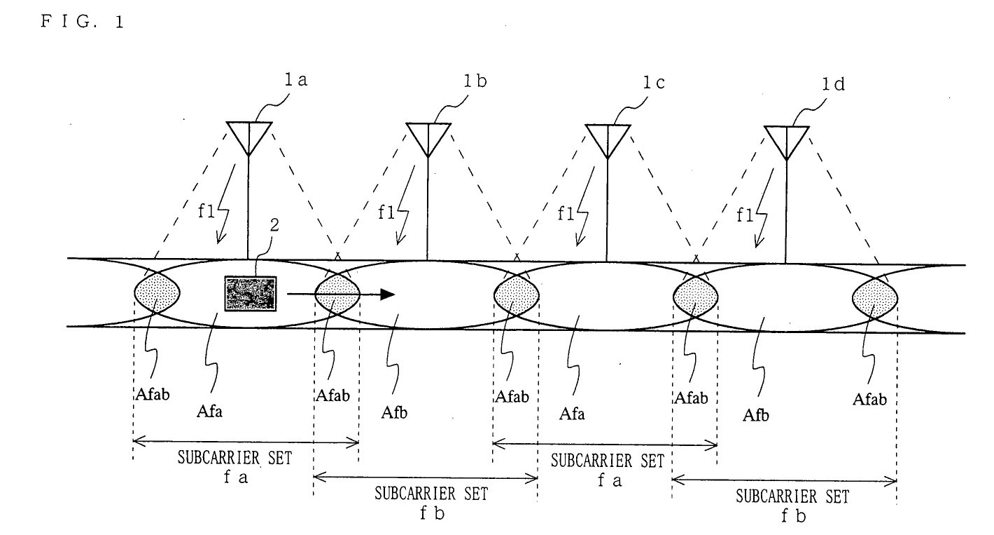

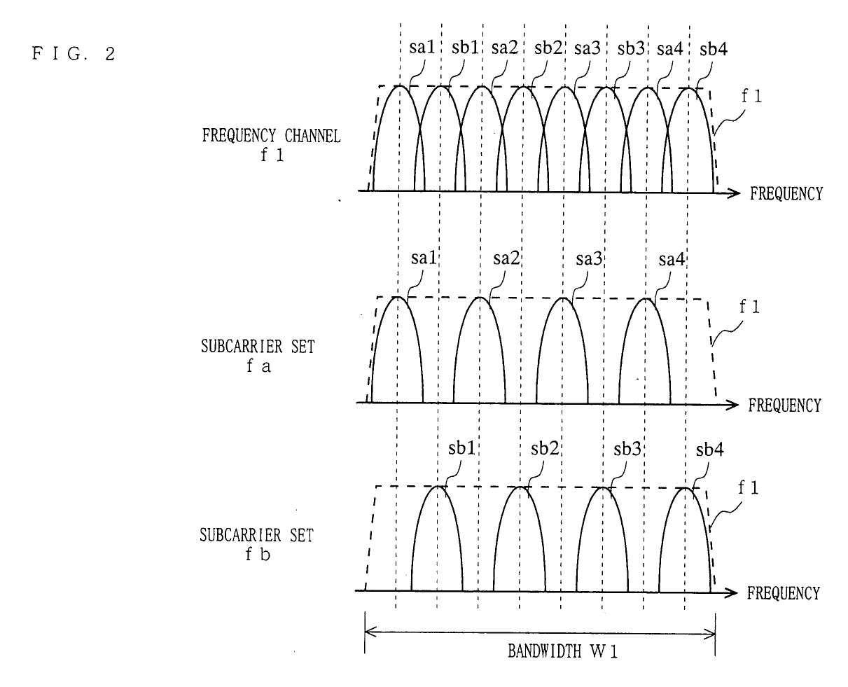

FIG. 1 is a schematic diagram illustrating a mobile communication system according to a first embodiment of the present invention. FIG. 2 is a diagram for explaining a method of arranging subcarriers used in the mobile communication system of the first embodiment of the present invention. The mobile communication system of the first embodiment of FIG. 1 is configured to use the same frequency channel f1 (bandwidth W1) to perform communication of the same data between a plurality of base stations 1a to 1d arranged along a road, and a traveling mobile station 2, such as a vehicle or the like, while sequentially establishing synchronization therebetween.

Regarding the configuration, the mobile communication system of the present invention is characterized in that subcarriers for communication which are assigned to the base stations 1a to 1d are set to satisfy the following conditions.

1. The same frequency channel f1 is used for all the base stations.

2. Subcarriers do not overlap between adjacent base stations.

3. Adjacent subcarriers are not used in each subcarrier set.

4. All subcarriers within the frequency channel f1 (subcarriers having closest intervals which can hold an orthogonal relationship) are used.

FIG. 2 illustrates an exemplary assignment of subcarriers which satisfies the conditions. Although FIG. 2 illustrates two subcarrier sets fa and fb, the number of subcarrier sets may be three or more.

In the example of FIGS. 1 and 2, the subcarrier set fa including subcarriers sa1 to sa4 is assigned to the base stations 1a and 1c, and the subcarrier set fb including subcarriers sb1 to sb4 is assigned to the base stations 1b and 1d. In FIG. 1, the mobile station 2 moves in a direction indicated with an arrow within communication areas formed by the base stations 1a to 1d. When the mobile station 2 communicates with the base stations 1a and 1c, the subcarrier set fa is used. When the mobile station 2 communicates with the base stations 1b and 1d, the subcarrier set fb is used. Specifically, the mobile station 2 receives a signal of the subcarrier set fa or fb which exclude specific subcarriers, within a communication area Afa or Afb, and receives a signal of all the subcarriers of the frequency channel f1 within the communication area Afab, and performs a demodulation process.

Next, a configuration and an operation of the base stations 1a to 1d of the first embodiment will be described.

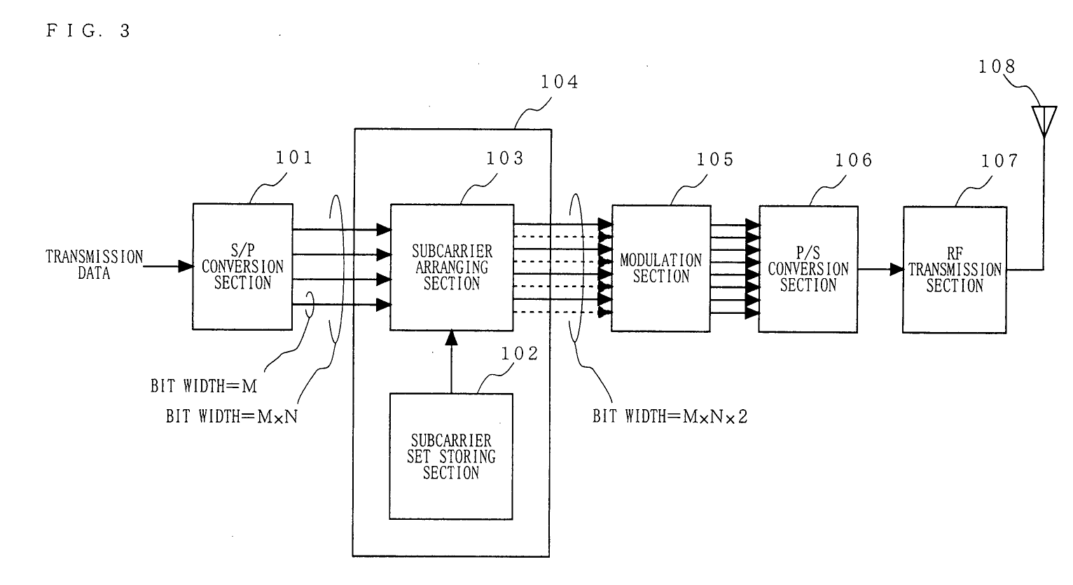

FIG. 3 is a block diagram illustrating an exemplary configuration of the base stations 1a to 1d of the first embodiment. In FIG. 3, the base stations 1a to 1d each comprise an S/P conversion section 101, a transmission data constructing section 104, a modulation section 105, a P/S conversion section 106, an RF transmission section 107, and an antenna 108. The transmission data constructing section 104 comprises a subcarrier set storing section 102 and a subcarrier arranging section 103.

The S/P conversion section 101 converts received transmission data into symbol data having a bit width of M corresponding to a transmission rate used in a multicarrier modulating technique. Further, the S/P conversion section 101 converts the converted symbol data into a parallel format having a width equal to the number N of subcarriers used in each subcarrier set (N=4 in FIG. 2), to generate parallel transmission data having a bit width represented by M×N.

The subcarrier set storing section 102 previously stores information about subcarriers included in a subcarrier set used by a base station. In the example of FIG. 2, information about the subcarriers sa1 to sa4 included in the subcarrier set fa is stored for the base stations 1a and 1c, and information about the subcarriers sb1 to sb4 included in the subcarrier set fb is stored for the base stations 1b and 1d.

The subcarrier arranging section 103 converts the parallel transmission data having a bit width of M×N generated by the S/P conversion section 101 into modulation data having a bit width of M×N×2. In this case, the subcarrier arranging section 103 arranges the symbol data having a bit width of M with respect to only subcarriers stored in the subcarrier set storing section 102, and inserts zero data having a bit width of M into subcarriers which are not stored in the subcarrier set storing section 102, assuming that such subcarriers are null carriers. In FIG. 3, among the modulation data having a bit width of M×N×2 which is a signal output by the subcarrier arranging section 103, output signals of subcarriers used are indicated with solid line arrows, and output signals of null carriers are indicated with dashed line arrows. Thereby, modulation data including only subcarriers used by a base station can be generated.

The modulation section 105 modulates the modulation data output from the transmission data constructing section 104 based on a multicarrier modulating technique, to generate a base-band transmission signal. This process can be achieved by using, for example, Inverse Discrete Fourier Transform (IDFT), or Inverse Fast Fourier Transform (IFFT) which accelerates inverse discrete Fourier transform, when an OFDM modulation method is used. The P/S conversion section 106 converts the base-band transmission signal in the parallel format generated by the modulation section 105 into a time-series base-band transmission signal in a serial format. The RF transmission section 107 converts the base-band transmission signal converted into the serial format into an analog signal, up-converts the analog signal into a predetermined frequency band within the frequency channel f1, and outputs the resultant signal as a wireless transmission signal through the antenna 108.

Next, a configuration and an operation of the mobile station 2 in the first embodiment will be described.

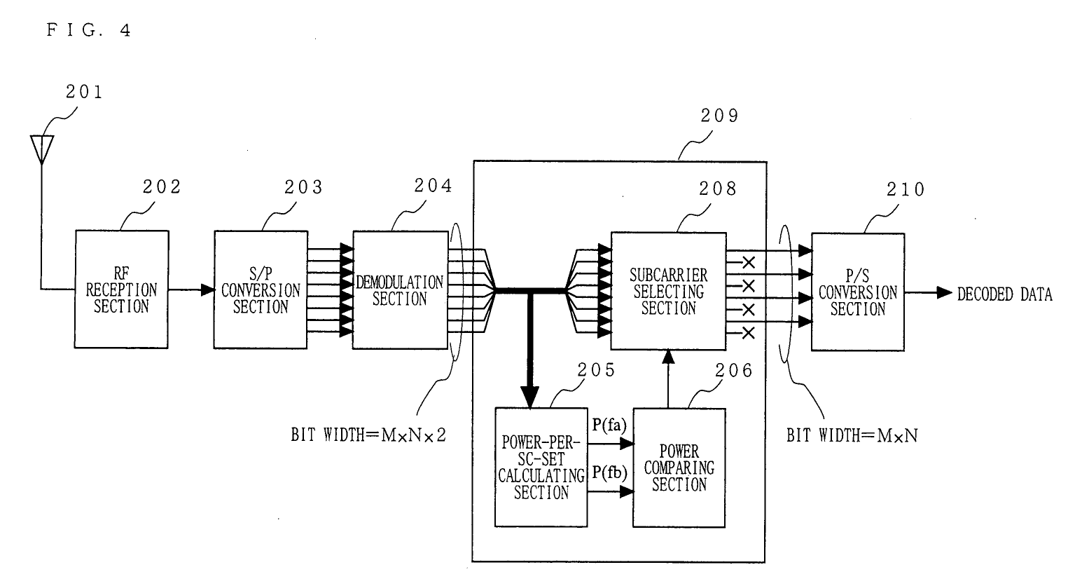

FIG. 4 is a block diagram illustrating an exemplary configuration of the mobile station 2 of the first embodiment. In FIG. 4, the mobile station 2 comprises an antenna 201, an RF reception section 202, an S/P conversion section 203, a demodulation section 204, a demodulated data selection combining section 209, and a P/S conversion section 210. The demodulated data selection combining section 209 comprises a section 205 for calculating a power for each subcarrier (SC) set (power-per-SC-set calculating section 205), a power comparing section 206, and a subcarrier selecting section 208. Note that, in FIG. 4, parallel demodulated data having a bit width of M×N×2 are collectively indicated with a thick line.

The RF reception section 202 down-converts a signal received through the antenna 201 into an intermediate frequency signal, and thereafter, converts the intermediate frequency signal into a base-band received signal in a serial format. The S/P conversion section 203 converts the serial-format base-band received signal into a parallel-format base-band received signal. The demodulation section 204 demodulates the parallel-format base-band received signal based on a multicarrier demodulating technique, to generate parallel demodulated data having a bit width of M×N×2. This process can be achieved by using, for example, Discrete Fourier Transform (DFT), or Fast Fourier Transform (FFT) which accelerates discrete Fourier transform, when an OFDM modulation method is used.

The demodulated data selection combining section 209 extracts only parallel demodulated data of subcarriers included in a desired subcarrier set, as parallel received data, from the parallel demodulated data generated by the demodulation section 204. This is because the mobile station 2 needs to obtain decoded data using a received signal of one of the subcarrier sets which is determined to be appropriate while moving communication areas which employ the two subcarrier sets fa and fb and are formed by the base stations 1a to 1d. The determination is performed by the power-per-SC-set calculating section 205 and the power comparing section 206 as follows.

When receiving the parallel demodulated data from the demodulation section 204, the power-per-SC-set calculating section 205 calculates a sum of powers of frequency bands occupied by N subcarriers included in each subcarrier set. In FIG. 4, the power sums of the subcarrier sets fa and fb are indicated by P(fa) and P(fb), respetively. The power comparing section 206 selects a larger one of the power sums P(fa) and P(fb) calculated by the power-per-SC-set calculating section 205, and outputs information about subcarriers included in the selected subcarrier set. Note that, when the calculated power sums of the subcarrier sets are equal to each other, an appropriate subcarrier set may be selected based on a history so far stored in a memory section (not shown), such as a register or the like, or a subcarrier set previously selected may be selected.

The subcarrier selecting section 208 outputs parallel demodulated data of only subcarriers corresponding to the information output from the power comparing section 206, as parallel received data having a bit width of M×N, among the parallel demodulated data having a bit width of M×N×2 output from the demodulation section 204. The P/S conversion section 210 converts the parallel-format received data having a bit width of M×N output from the subcarrier selecting section 208 into serial-format received data, which is in turn output.

Next, a method for achieving handover in the mobile communication system of the present invention will be described. All the subcarrier sets used in the base stations 1a to 1d are signals on the same frequency channel f1, and the mobile station 2 invariably receives a signal on the frequency channel f1. Therefore, in the mobile communication system of the present invention, even when handover is required, it is not necessary to change frequency channels. Specifically, the mobile station 2 does not perform a complicated process, such as frequency resynchronization or the like, and determines which of the two subcarrier sets is used in a communication area in which the mobile station 2 is moving, and obtains decoded data using a received signal of a subcarrier set which is determined to be appropriate, thereby making it possible to easily achieve handover. In addition, since one which has better quality is selected from the two subcarrier sets, the communication quality can be improved.

As described above, according to the mobile communication system of the first embodiment of the present invention, subcarriers which are assigned to a plurality of base stations are set based on the following conditions: the same frequency channel is used for all the base stations; subcarriers do not overlap between adjacent base stations; adjacent subcarriers are not used in each subcarrier set; and all subcarriers within the frequency channel are used. Thereby, a frequency interval between each subcarrier is broadened, thereby making it possible to suppress the occurrence of ICI due to a Doppler shift during high-speed movement. A mobile station does not need to change frequency channels for a received signal during handover, so that a handover process can be easily performed only by changing subcarrier sets used. Since all subcarriers included in a frequency channel are used, there is not a reduction in the frequency efficiency. Since subcarriers do not overlap between adjacent base stations, received signals are not canceled in an overlapping communication area.

Note that, in the demodulated data selection combining section 209 of the first embodiment, although a selection combination method of selecting and modulating one subcarrier set is illustrated, an equal gain combination method or a maximum ratio combination method described in Non-patent Document 2 (Yoshihisa Okumura and Masaaki Shinji, “Basic Mobile Communications”, The Institute of Electronics, Information and Communication Engineers, 1986) may be used. When a CRC is added to a signal which is transmitted from a base station, all subcarrier sets are demodulated, and one which has a small CRC error may be selected, or one which establishes frame synchronization may be selected. Note that, when the maximum ratio combination method is used, a demodulation result is subjected to weighted addition, depending on the magnitudes of CNRs of two subcarrier sets, thereby making it possible to maximize the CNR of a combined received wave. Thereby, there is a possibility that errors in an overlapping communication area can be effectively reduced.

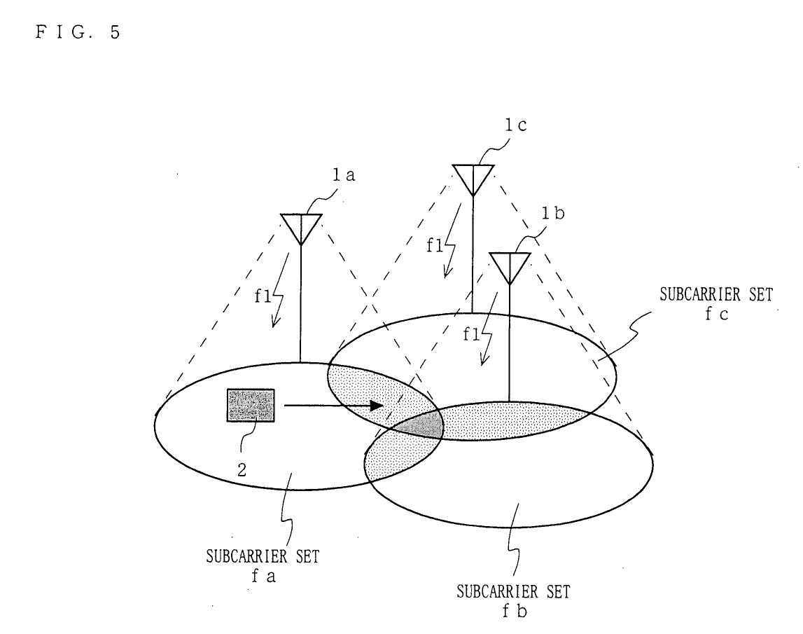

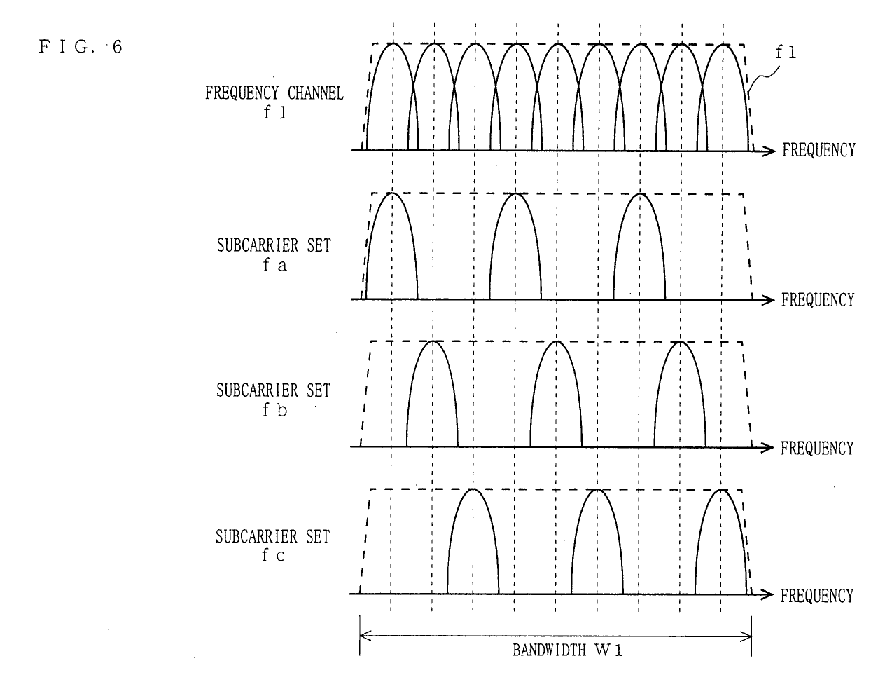

In the first embodiment, the communication areas formed by the mobile communication system are arranged one-dimensionally. Alternatively, the communication areas may be arranged two-dimensionally as illustrated in FIG. 5. For example, in the system of FIG. 5, subcarrier sets illustrated in FIG. 6 are used.

In the first embodiment, symbol data having a bit width of M is provided for each subcarrier in all subcarrier sets. Alternatively, the bit width may vary among the subcarrier sets. For example, the subcarrier set fa may include four subcarriers and symbol data having a bit width of M may be provided for each subcarrier, while the subcarrier set fb may include two subcarriers and symbol data having a bit width of 2M may be provided for each subcarrier.

### Second Embodiment

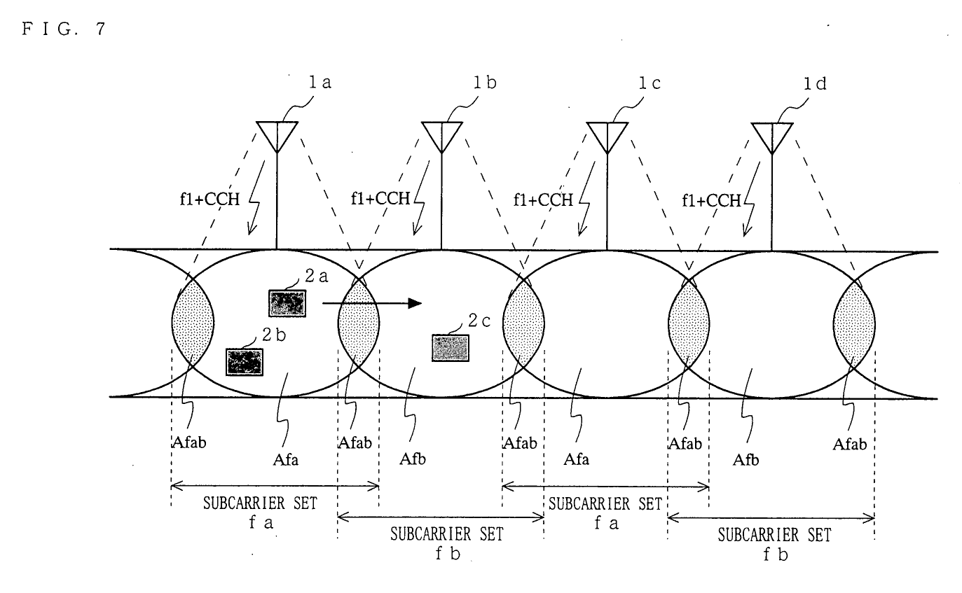

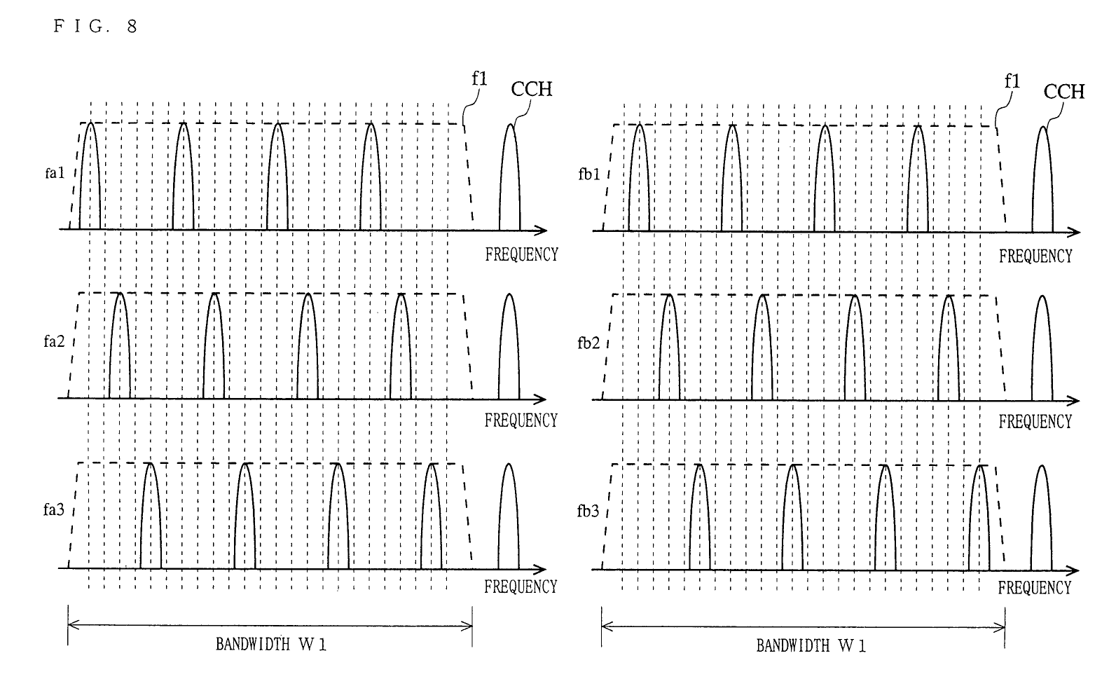

FIG. 7 is a schematic diagram illustrating a mobile communication system according to a second embodiment of the present invention. FIG. 8 is a diagram for explaining a method of arranging subcarriers used in the mobile communication system of the second embodiment of the present invention. The mobile communication system of the second embodiment has the same configuration as that of the first embodiment, except that a characteristic process is performed, corresponding to the case where a plurality of mobile stations 2a to 2c simultaneously move through one communication area.

The base stations 1a to 1d are assigned with the subcarrier sets fa and fb which satisfy the conditions 1 to 4 as described in the first embodiment. In the second embodiment, the subcarrier sets fa and fb are subdivided, so that a plurality of subcarrier sets fa1 to fa3 and fb1 to fb3 are provided as illustrated in FIG. 8. In addition, the base stations 1a to 1d communicate with the mobile stations 2a to 2c using the frequency channel f1 and a control channel CCH.

The mobile stations 2a to 2c each simultaneously receive the subcarrier sets fa1 to fa3 within the communication area Afa, each simultaneously receive the subcarrier sets fb1 to fb3 within the communication area Afb, and each simultaneously receive the subcarrier sets fa1 to fa3 and fb1 to fb3 within the communication area Afab, and perform a demodulation process.

Next, the control channel CCH will be described.

The control channel CCH is used to inform the respective corresponding mobile station 2a to 2c of respective subcarrier sets which are used by the mobile stations 2a to 2c within the communication areas Afa and Afb. FIG. 8 illustrates an exemplary arrangement on a frequency axis of the frequency channel f1 and the control channel CCH. In the example of FIG. 8, the control channel CCH is multiplexed with the frequency channel f1 at different frequencies. Note that one or more subcarriers included in the frequency channel f1 may be assigned to the control channel CCH. Since a control signal which is transmitted on the control channel CCH only needs to be multiplexed and transmitted with the frequency channel f1, FDMA, TDMA, CDMA, or OFDM-CDMA may be used, for example.

The base stations 1a to 1d transmit a control signal indicating a subcarrier set which is used in each of the mobile stations 2a to 2c, using the control channel CCH. For example, when the mobile station 2a which performs communication using the subcarrier set fa is present within the communication area Afa, the base station 1a informs the mobile stations 2a to 2c within the communication area Afa, via the control channel CCH, that the mobile station 2a is using the subcarrier set fa1, and the mobile station 2a will use the subcarrier set fb1 within the communication area Afb in which the mobile station 2a will travel next.

The mobile stations 2a to 2c each determine which subcarrier set is used within the communication areas Afa and Afb, based on the control signals which are transmitted from the base stations 1a to 1d using the carrier of the control channel CCH. For example, in the above-described case, the mobile station 2a extracts and determines the control signal from the carrier of the control channel CCH, and when the mobile station 2a communicates with the base station 1a, the mobile station 2a uses the subcarrier set fa1, and when the mobile station 2a communicates with the base station 1b, the mobile station 2a uses the subcarrier set fb1.

Next, a configuration and an operation of the base stations 1a to 1d of the second embodiment will be described.

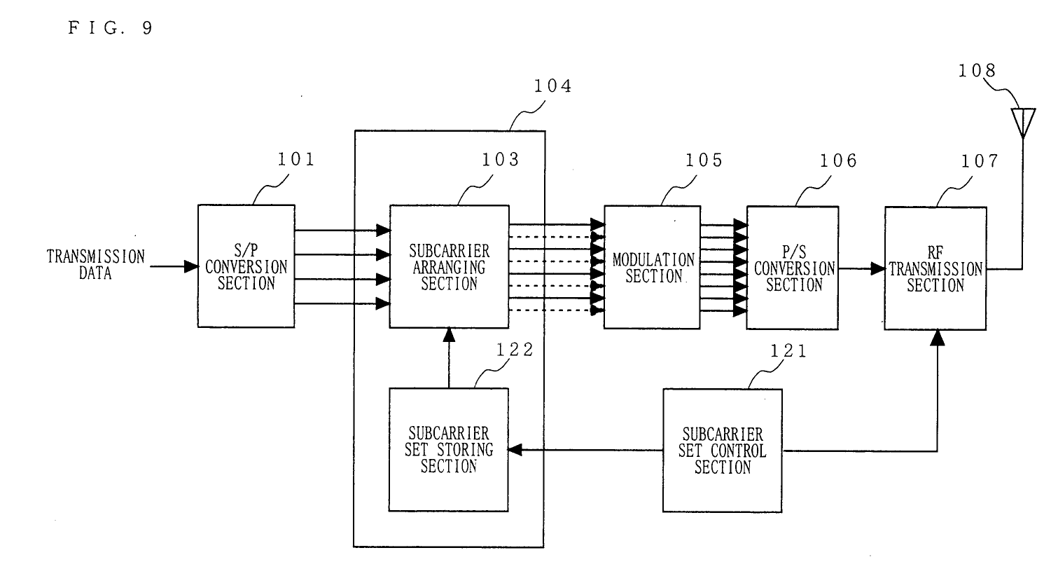

FIG. 9 is a block diagram illustrating an exemplary configuration of the base stations 1a to 1d of the second embodiment. In FIG. 9, the base stations 1a to 1d each comprise an S/P conversion section 101, a subcarrier set control section 121, a subcarrier set storing section 122, a subcarrier arranging section 103, a modulation section 105, a P/S conversion section 106, an RF transmission section 107, and an antenna 108. The base stations 1a to 1d of the second embodiment is different from the base stations 1a to 1d of the first embodiment in the subcarrier set control section 121 and the subcarrier set storing section 122.

The subcarrier set control section 121 generates a control signal for informing the mobile stations 2a to 2c of a subcarrier set used in a base station forming a communication area in which a vehicle is currently traveling, and a subcarrier set used in a base station forming a communication area in which the vehicle will travel next. At the same time, the subcarrier set control section 121 stores the subcarrier sets which the own base station uses to communicate with the mobile stations 2a to 2c, in the subcarrier set storing section 122. Thereby, the transmission data constructing section 104 can arrange transmission data which is to be transmitted to the mobile stations 2a to 2c, to only subcarriers included in the subcarrier sets which are used by the mobile stations 2a to 2c.

Next, a configuration and an operation of the mobile stations 2a to 2c of the second embodiment will be described.

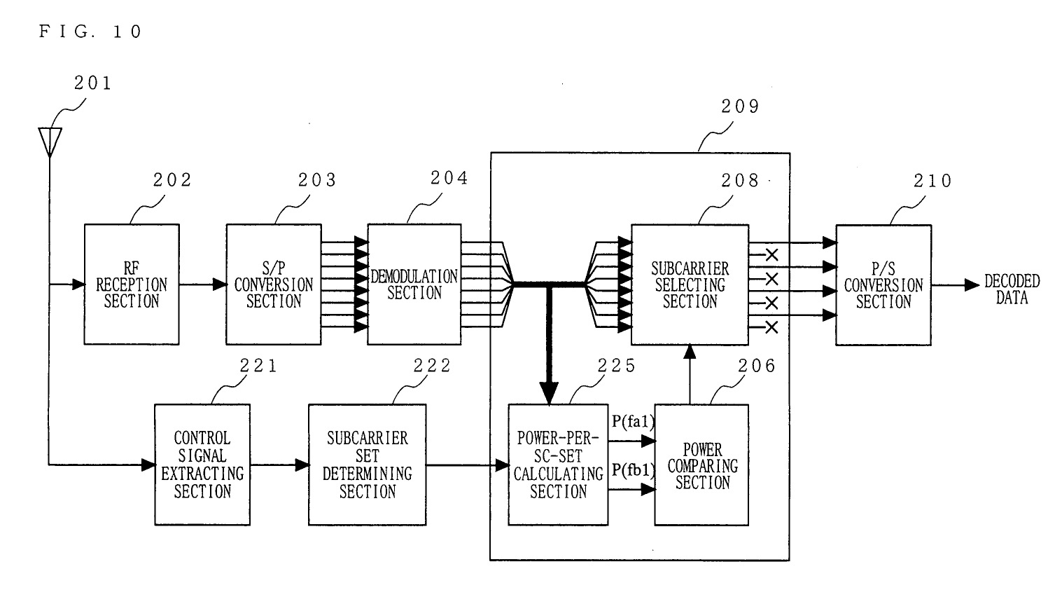

FIG. 10 is a block diagram illustrating an exemplary configuration of the mobile stations 2a to 2c of the second embodiment. In FIG. 10, the mobile stations 2a to 2c each comprise an antenna 201, an RF reception section 202, an S/P conversion section 203, a demodulation section 204, a power-per-SC-set calculating section 225, a power comparing section 206, a subcarrier selecting section 208, a P/S conversion section 210, a control signal extracting section 221, and a subcarrier set determining section 222. The mobile stations 2a to 2c of the second embodiment is different from the mobile station 2 of the first embodiment in the power-per-SC-set calculating section 225, the control signal extracting section 221, and the subcarrier set determining section 222.

The control signal extracting section 221 extracts a control signal which is transmitted using the carrier of the control channel CCH, from a signal received through the antenna 201. From the control signal extracted by the control signal extracting section 221, the subcarrier set determining section 222 determines a subcarrier set which is used within a communication area in which the own mobile station is currently moving and a subcarrier set which will be used within the communication area in which the mobile station will travel next. When the power-per-SC-set calculating section 225 receives parallel demodulated data from the demodulation section 204, the power-per-SC-set calculating section 225 calculates the power sums of frequency bands occupied by subcarriers included in the two subcarrier sets which have been determined by the subcarrier set determining section 222. In FIG. 10, the power sums of the subcarrier sets fa1 and fb1 are indicated by P(fa1) and P(fb1), respectively.

As described above, according to the mobile communication system of the second embodiment of the present invention, subcarriers assigned to each base station are subdivided. Thereby, in addition to the effect of the first embodiment, even when a plurality of mobile stations are present within the same communication area, a frequency interval between each subcarrier can be broadened, thereby making it possible to suppress occurrence of ICI due to a Doppler shift during high-speed movement.

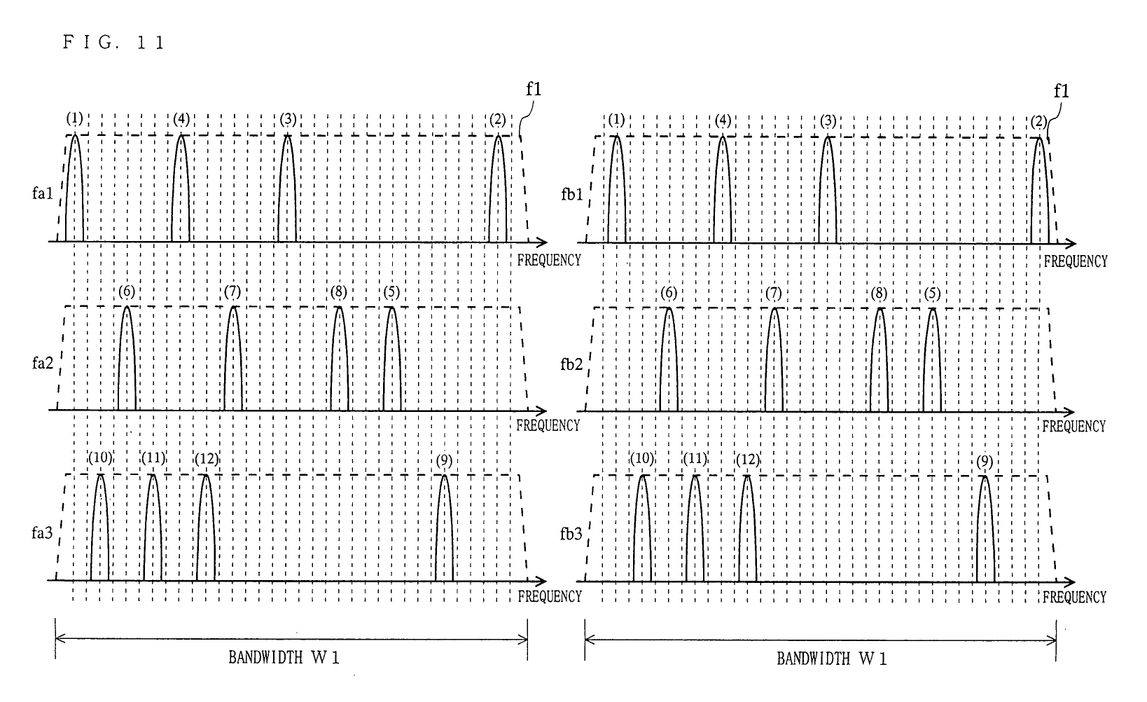

Note that, as another method of arranging subcarriers in the second embodiment, a method illustrated in FIG. 11 may be used, for example. In this method, subcarriers are arranged so as not to be biased to a certain frequency. This arrangement method is applied to the case where the frequency channel f1 is divided into the subcarrier sets fa and fb as follows.

For the subcarrier set fa, initially, a subcarrier which has a lowest frequency within the frequency channel f1 is determined as “number (1)”, and a subcarrier which has a second highest frequency is determined as “number (2)”. Next, a subcarrier which has a middle frequency between those of number (1) and number (2) is determined as “number (3)”. Next, a subcarrier which has a middle frequency between those of number (1) and number (3) is determined as “number (4)”. Next, a subcarrier which has a middle frequency between those of number (2) and number (3) is determined as “number (5)”. In this manner, a subcarrier is sequentially provided at a middle position between two subcarriers having a broad frequency interval. Note that the subcarrier set fb may be obtained by shifting subcarriers arranged in the subcarrier set fa to frequencies which are higher by one.

In the second embodiment, it has been described that information about a communication area in which a mobile station will travel next, is transferred from a base station to the mobile station. Alternatively, the mobile station can transfer the information to the base station. For example, a next communication area in which a mobile station will travel can be determined by using positional information obtained by a GPS capable of detecting the mobile station, information indicating a traveling direction obtained by a car navigation system carried on the mobile station, or the like.

### Third Embodiment

In the mobile communication systems of the first and second embodiments, it is assumed that a mobile station(s) moves with high speed, and therefore, code error which occurs during handover needs to be taken into consideration in practical situations. Therefore, in a third embodiment, a mobile communication system in which an interleaving process and an error correction encoding process are used to reduce the influence of code error, will be described. Note that, in the third embodiment, the same parts as those of the first embodiment will not be described.

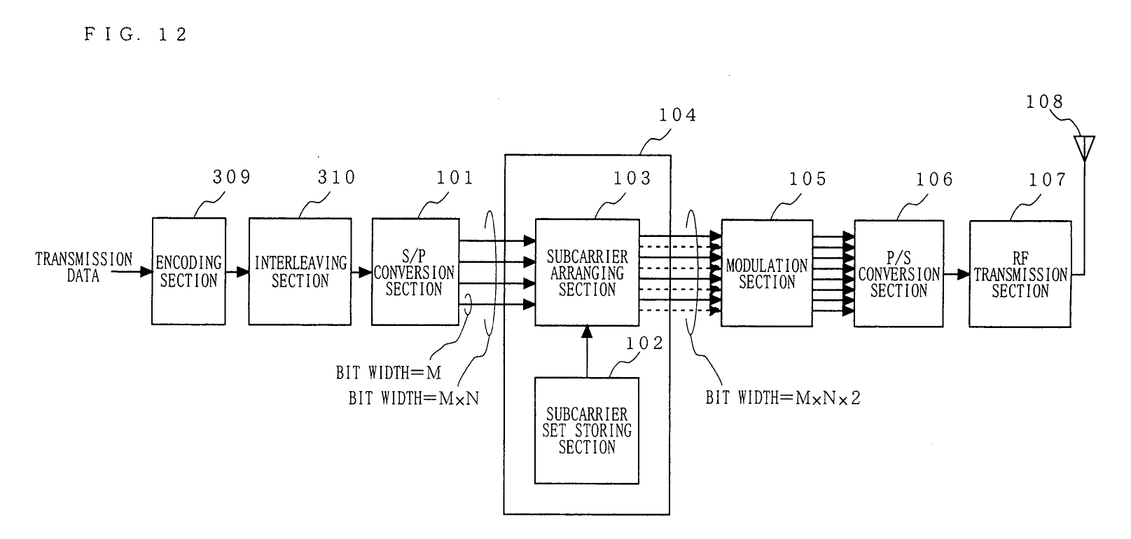

FIG. 12 is a block diagram illustrating an exemplary configuration of base stations 1a to 1d included in the mobile communication system of the third embodiment of the present invention. In FIG. 12, the base stations 1a to 1d each comprise an encoding section 309, an interleaving section 310, an S/P conversion section 101, a transmission data constructing section 104, a modulation section 105, a P/S conversion section 106, an RF transmission section 107, and an antenna 108. As illustrated in FIG. 12, the base stations 1a to 1d of the third embodiment are different from the base stations 1a to 1d of the first embodiment in the encoding section 309 and the interleaving section 310.

The encoding section 309 subjects received serial-format transmission data to an error correction encoding process to generate encoded transmission data. The type of an error correction code used in the encoding section 309 is not particularly limited, and for example, a convolutional code can be used. The interleaving section 310 performs an interleaving process which rearranges a temporal sequence of the encoded transmission data generated by the encoding section 309, to generate interleaved transmission data. The S/P conversion section 101 subjects the interleaved transmission data to a serial/parallel conversion process.

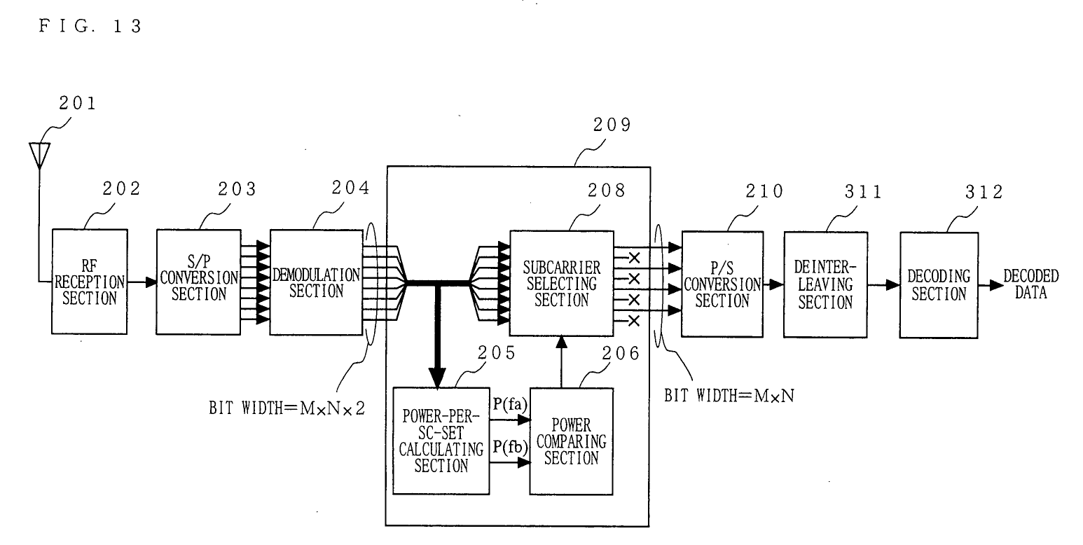

FIG. 13 is a block diagram illustrating an exemplary configuration of a mobile station 2 included in the mobile communication system of the third embodiment of the present invention. In FIG. 13, the mobile station 2 comprises an antenna 201, an RF reception section 202, an S/P conversion section 203, a demodulation section 204, a demodulated data selection combining section 209, a P/S conversion section 210, a deinterleaving section 311, and a decoding section 312. As illustrated in FIG. 13, the mobile station 2 of the third embodiment is different from the mobile station 2 of the first embodiment in the deinterleaving section 311 and the decoding section 312.

The deinterleaving section 311 rearranges and reverses the temporal sequence of serial-format received data converted by the P/S conversion section 210, as compared to the interleaving section 310 in the base station. By the rearrangement process of the deinterleaving section 311, burst errors which occurred at a certain time can be caused to be temporally sparse and be evened to effectively perform error correction. Thereafter, the decoding section 312 subjects the serial-format received data whose temporal sequence has been rearranged into the original sequence by the deinterleaving section 311, to an error correction decoding process, and outputs the result as decoded data.

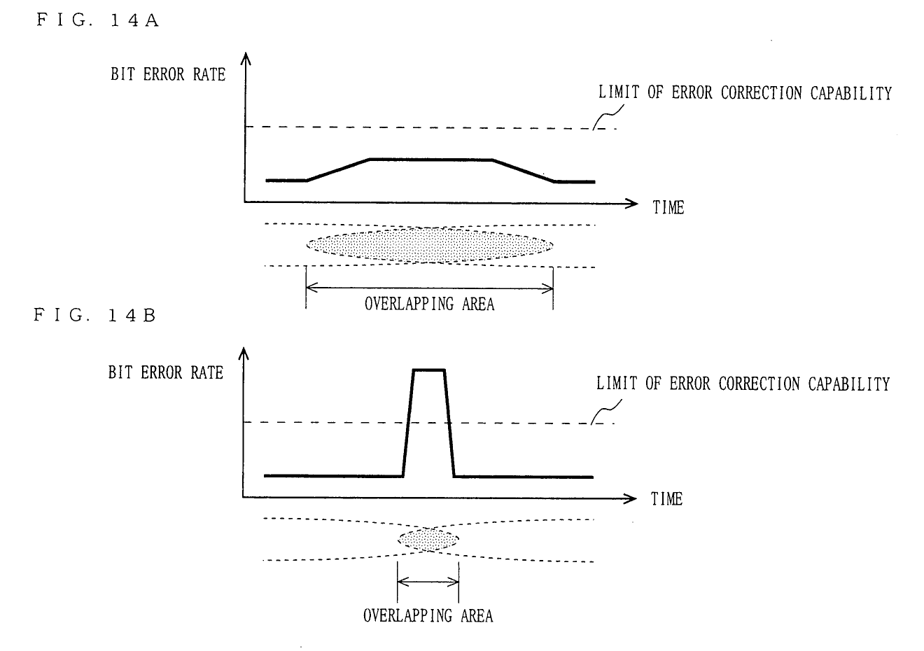

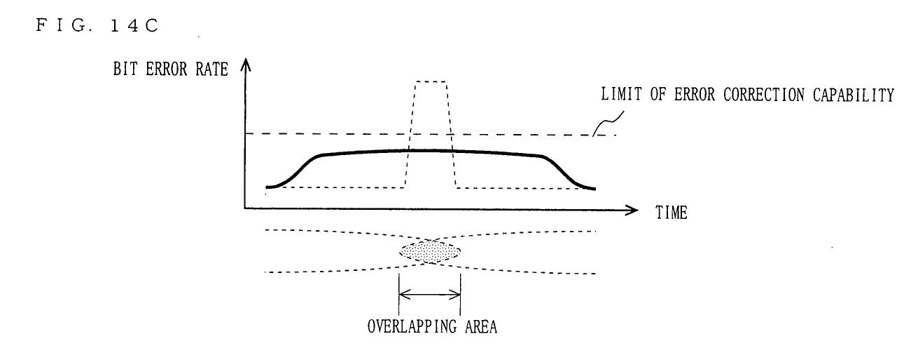

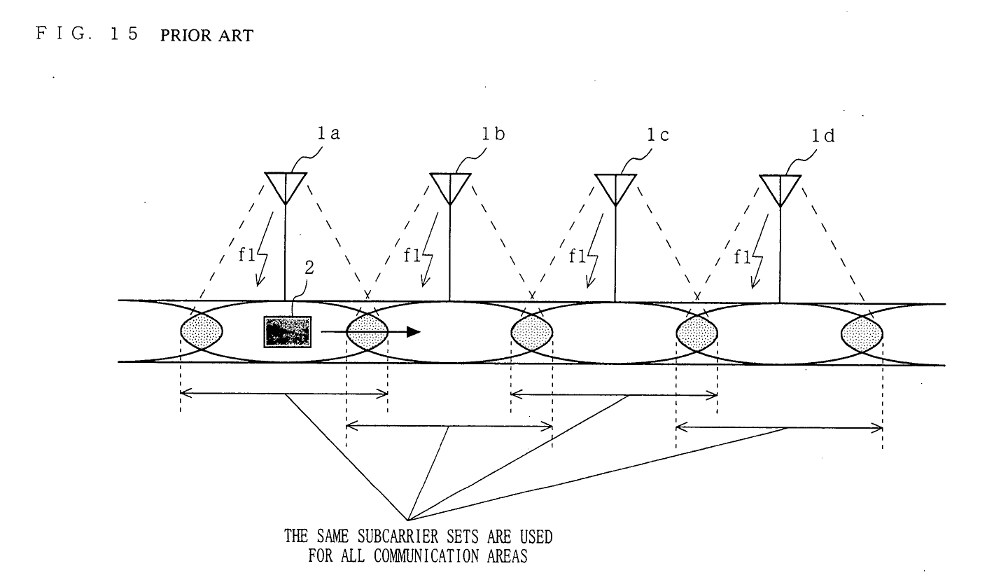

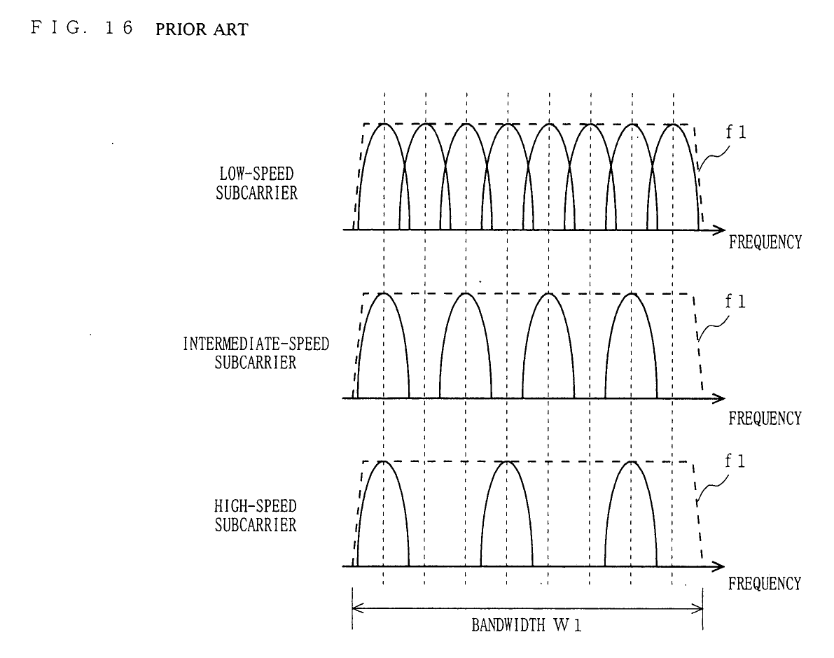

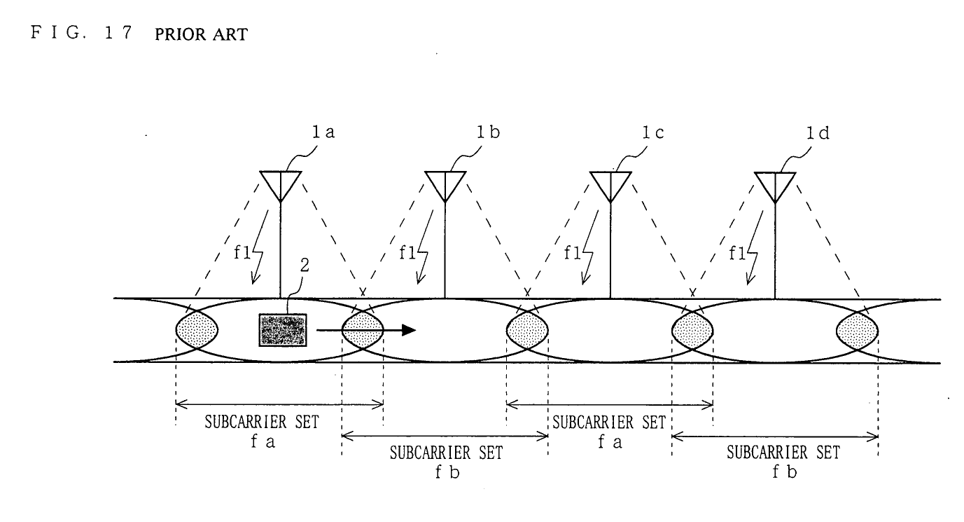

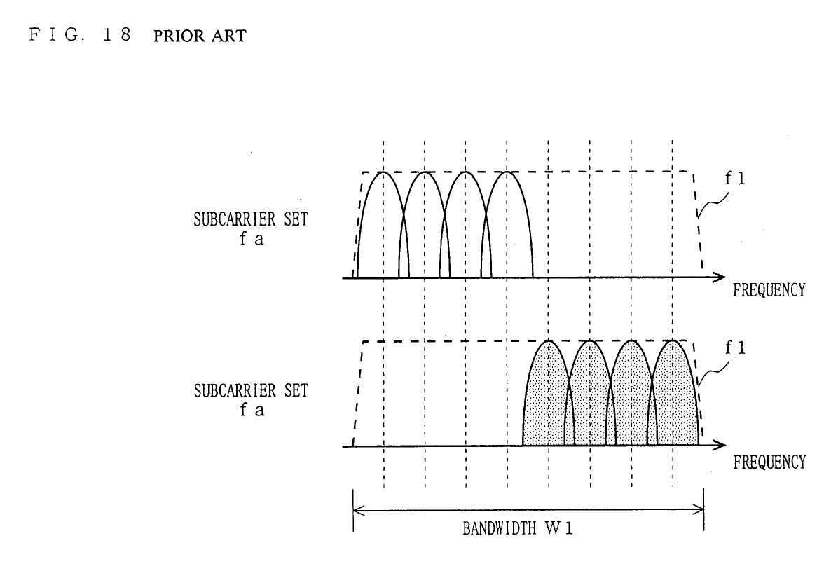

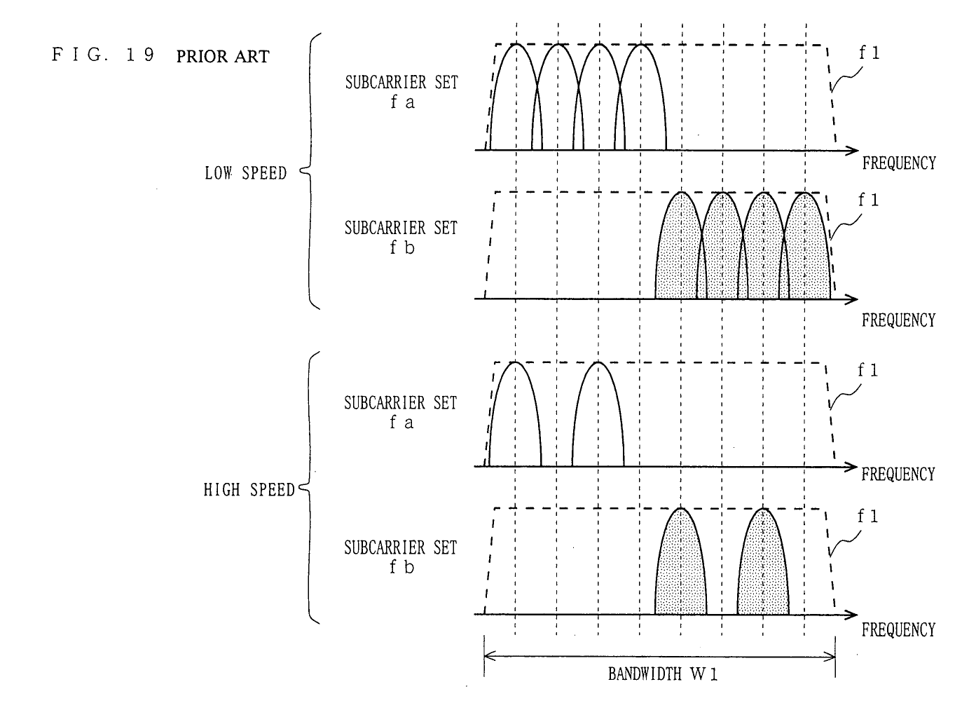

FIGS. 14A and 14B are conceptual diagrams illustrating a relationship between a passage time when the mobile station 2 passes in and near an overlapping communication area (horizontal axis) and a bit error rate (vertical axis). FIG. 14A illustrates the case of low-speed movement, and FIG. 14B illustrates the case of high-speed movement. A portion under the horizontal axis of each figure illustrates a positional relationship between the passage time of the mobile station 2 in and near the overlapping communication area, and communication areas.

Firstly, an operation of the interleaving section 310 when passing through the overlapping communication area will be specifically described. In the mobile communication system of the present invention, a signal received by the mobile station 2 in the overlapping communication area is an addition of the subcarrier sets fa and fb, i.e., a signal in which all subcarriers of the frequency channel f1 are provided. In the overlapping communication area, the signal received by the mobile station 2 has a narrow frequency interval between each subcarrier, and therefore, ICI more easily occurs as compared to a signal received by the mobile station 2 in places other than the overlapping communication area. As a result, bit error highly likely occurs in the mobile station 2.

FIG. 14A illustrates that it takes a long time for a the mobile station 2 moving with low speed to pass though the overlapping communication area, and the bit error rate does not exceed the error correction capability of an error correction code processed by the encoding section 309. When the mobile station 2 moves with low speed, errors occurring in the mobile station 2 are completely removed by an error correction function of the decoding section 312, thereby making it possible to achieve error-free communication.

On the other hand, FIG. 14B illustrates that it takes a short time for the mobile station 2 moving with high speed to pass through the overlapping communication area, and a bit error rate occurring during the time exceeds the error correction capability of the error correction code processed by the encoding section 309. Thus, when the mobile station 2 moves in the overlapping communication area with high speed, errors occurring in the overlapping communication area highly likely exceed the error correction capability of the encoding section 309 unlike the case of FIG. 14A, however, the occurrence time is considerably short.

In view of this point, the interleaving section 310 subjects transmission data to a temporal interleaving process with which an instantaneous error can be previously suppressed into a range within which the error can be corrected. Thereafter, the deinterleaving section 311 spreads an instantaneous error occurring at a certain time over a plurality of symbols to even the error. Thereby, errors occurring in the overlapping communication area can be suppressed into the error correction capability range of the decoding section 312. Therefore, by using the error correction code processed by the encoding section 309, the mobile station 2 can completely remove errors (see FIG. 14C). Therefore, the influence of ICI due to a Doppler shift during high-speed movement can be removed.

Note that, as a specific method of setting a time unit (interleave length) for performing an interleaving process, for example, in the case of FIGS. 14A to 14C, a time interleave length Ti[s] may be set to be Ti>Tp·E/Emax, where the passage time of the overlapping communication area is represented by Tp[s], an error rate for the passage time is represented by E, and the limit of an error correction range is represented by Emax. Thereby, an error can be suppressed into a range within which the error correction code processed by the encoding section 309 can be corrected. Therefore, even when the mobile station 2 passes through the overlapping communication area while moving with high speed, stable communication can be achieved.

As described above, according to the mobile communication system of the third embodiment of the present invention, an interleaving process and an error correction encoding process are used. Thereby, in addition to the effect of the first embodiment, even when an error exceeding error correction capability occurs in an overlapping communication area, the error can be suppressed into the error correction capability range, whereby all data can be decoded. Therefore, highly reliable communication can be achieved either during low-speed or high-speed movement. Note that the configuration which employs the interleaving process and the error correction code can be applied to the second embodiment.

In the first to third embodiments, a mobile communication system in which communication is performed between a road and a vehicle(s) using a multicarrier modulating technique (an OFDM modulation method, a wavelet modulation method, etc.) is illustrated as an example to describe the mobile communication system of the present invention. However, the subcarrier sets which are characteristically assigned in the present invention are not limited to use in road-to-vehicle communication. For example, a subcarrier set which is not used within communication areas may be applied to vehicle-to-vehicle communication.

Note that functional blocks required to achieve the whole or a part of a base station included in the mobile communication systems of the first to third embodiments of the present invention may be implemented as an integrated circuit (LSI: LSI may be called IC, system LSI, super LSI or ultra LSI, depending on the packaging density). The functional blocks may be mounted on one chip, or a part or the whole of the functional blocks may be mounted on one chip.

The integrated circuit is not limited to LSI. The integrated circuit may be achieved by a dedicated circuit or a general-purpose processor. Further, an FPGA (Field Programmable Gate Array) which can be programmed after LSI production or a reconfigurable processor in which connection or settings of circuit cells in LSI can be reconfigured, may be used. The operations of these functional blocks can be performed using a DSP, a CPU, or the like. These process steps can be recorded and executed as a program in a recording medium.

Furthermore, if an integrated circuit technology which replaces LSI is developed by an advance in the semiconductor technology or other technologies derived therefrom, the functional blocks may be packaged using such a technology. A biotechnology may be applicable.

While the invention has been described in detail, the foregoing description is in all aspects illustrative and not restrictive. It is understood that numerous other modifications and variations can be devised without departing from the scope of the invention.

What is claimed is:

1. A base station included in a mobile communication system in which station-to-station communication is performed using a multicarrier modulating technique, comprising:
a subcarrier set storing section operable to store information about a subcarrier set designating a plurality of subcarriers used in communication;
a subcarrier arranging section operable to generate modulation data obtained by providing transmission data only to the plurality of subcarriers designated by the subcarrier set; and
a modulation section operable to modulate the modulation data generated by the subcarrier arranging section into a base-band transmission signal based on the multicarrier modulating technique,
wherein the plurality of subcarriers designated by the subcarrier set are included in the same frequency channel as that of at least another adjacent base station, and are different from subcarriers of the adjacent base station, and adjacent subcarriers are not used in each subcarrier set.

2. The base station according to claim 1, further comprising:
an S/P conversion section operable to convert serial-format transmission data into parallel-format transmission data and outputting the parallel-format transmission data to the subcarrier arranging section;
a P/S conversion section operable to convert the base-band transmission signal modulated by the modulation section into a serial format; and
an RE transmission section operable to convert the serial-format base-band transmission signal into an analog signal and up-convert the analog signal into a predetermined frequency band, and thereafter, output the resultant analog signal through an antenna.

3. The base station according to claim 2, further comprising:
an encoding section operable to subject the serial-format transmission data to an error correction encoding process to output an encoded transmission signal; and
an interleaving section operable to rearrange a temporal sequence of the encoded transmission signal and output the resultant encoded transmission signal to the S/P conversion section.

4. The base station according to claim 1, wherein the plurality of subcarriers designated by the subcarrier set are subdivided into a plurality of subcarrier sets, and broadcast communication can be performed with respect to a plurality of mobile stations within a communication area using the plurality of subcarrier sets.

5. The base station according to claim 4, wherein a control signal for informing of a subcarrier set used for communication is transmitted to the plurality of mobile stations within a communication area using a carrier of a predetermined control channel.

6. The base station according to claim 4, wherein a control signal for informing of a subcarrier set used for communication is transmitted to the plurality of mobile stations within a communication area using a specific subcarrier of the plurality of subcarriers.

7. The base station according to claim 1, wherein, in the frequency channel, a plurality of subcarriers are arranged in closest intervals which can hold an orthogonal relationship between each subcarrier.

8. A mobile station included in a mobile communication system in which station-to-station communication is performed using a multicarrier modulating technique, comprising:
a demodulation section operable to demodulate a base-band received signal into demodulated data based on the multicarrier modulating technique; and
a demodulated data selection combining section operable to determine which of a plurality of predetermined subcarrier sets was used to transmit data, based on the demodulated data, and generate received data obtained by selecting a plurality of subcarriers designated by the determined subcarrier set, from the demodulated data,
wherein all subcarriers designated by the plurality of subcarrier sets are included in the same frequency channel, the subcarriers are different between each subcarrier set, and adjacent subcarriers are not used in each subcarrier set.

9. A method for performing communication between a base station and a mobile station using a multicarrier modulating technique, wherein
in the base station, the method comprises the steps of:
previously storing information about a subcarrier set designating a plurality of subcarriers used in communication in a predetermined storing section;
generating modulation data obtained by providing transmission data only to the plurality of subcarriers designated by the subcarrier set; and
modulating the generated modulation data into a base-band transmission signal based on the multicarrier modulating technique, and
in the mobile station, the method comprises the steps of:
demodulating a base-band received signal into demodulated data based on the multicarrier modulating technique;
determining which of the plurality of predetermined subcarrier sets was used to transmit data, based on the demodulated data; and
generating received data obtained by selecting a plurality of subcarriers designated by the determined subcarrier set, from the demodulated data,
wherein the plurality of subcarriers designated by the subcarrier set are included in the same frequency channel as that of at least another adjacent base station, and are different from subcarriers of the adjacent base station, and adjacent subcarriers are not used in each subcarrier set.
